(19) United States
(12) Patent Application Publication
(10) Pub. No.: US 2003/0123541 A1
(43) Pub. Date: Jul. 3, 2003

(54) Shot transition detecting method for video stream

(75) Inventors: Sung Bae Jun, Seoul (KR); Kyoung Ro Yoon, Seoul (KR)

Correspondence Address: LEE & HONG, 801 SOUTH FIQUEROA STREET, 14TH FLOOR, LOS ANGELES, CA, 90017, US

(73) Assignee: LG Electronics, Inc.

(21) Appl. No.: 10/263,051

(22) Filed: Oct. 1, 2002

(30) Foreign Application Priority Data
Dec. 29, 2001 (KR) 88260/2001

(51) Int. Cl. H04N 7/12

(52) U.S. Cl. 375/240.08; 382/168

(57) ABSTRACT

Disclosed herein is a method of detecting a shot transition of a moving picture video, comprising the steps of: extracting a color histogram of three adjacent frames in order on time series; obtaining a difference of the color histogram between the three adjacent frames and then detecting a shot transition candidate interval by concurrently using arrangement characteristics of the difference of the color histogram; and examining a distribution of a macro block type within the shot transition candidate interval and verifying whether a shot transition is present or not within the shot transition candidate interval.

### BACKGROUND OF THE INVENTION

1. Field of the Invention

The present invention relates generally to a method for automatically detecting a transition of video shot, and more particularly to a method of minimizing a false alarm occurring in the algorithm for automatically detecting a transition of video shot, by using multi-level color histogram comparisons.

2. Description of the Prior Art

A non-linear video search and browsing employs a shot segmentation method. A term “shot” is referred to a sequence of video stream obtained, without any interruption, by a single camera. A video is configured by an interconnection of a number of shots and a variety of edition effects are used to interconnect the shots.

The edition effects used for a video edition generally include an abrupt shot transition and a gradual shot transition. The gradual shot transition includes a fade, a dissolve, a wipe, etc. The abrupt shot transition is also referred to as a hard cut.

Based on results of various researches, it is reported that a shot segmentation method using a global color distribution provides a satisfactory outcome. In addition, for accomplishing a fast and precise algorithm, a video codec using a bi-directional compression, such as a MPEG (Moving Picture Expert Group), tries to detect a more precise shot transition by modeling a type distribution characteristic of macro blocks in a shot transition interval.

Typically, difference of color distribution between adjacent frames is very large in positions where the hard cut occurs. So, the hard cut is detected by using such a property.

On the other hand, for accomplishing a faster detection of shot transition, the information on the color histogram is extracted in predetermined several frame intervals without being extracted in each frame. In addition, in a video coding scheme such as the MPEG, the information on the color histogram is extracted by the unit of I frame which is encoded independently and then is used for the shot segmentation algorithm.

Recently, for accomplishing a more faster shot segmentation algorithm, the color histogram is extracted from a reduced image such as a DC image, or sub-sampled image and then is used as input of the shot segmentation algorithm. In addition, it is known that there is no significant difference between the color histogram extracted from such a DC image or a sub-sampled image and the color histogram extracted from an original image.

In the meantime, a recent shot segmentation algorithm detects not only whether a shot transition actually occurred but also a precise position where the shot transition occurred in a shot transition candidate interval obtained by performing a color histogram comparison, by using macro block type information or motion vector information.

Existing shot transition detecting algorithms use a color histogram between two adjacent frames or two frames apart by a specific time interval from each other as an important input of the shot segmentation.

However, a relative significant difference of image between two adjacent frames or two frames apart by a specific time interval from each other appears not only at a shot transition point but also a camera flash, a fast motion interval of a large object, a fast camera motion interval, etc, cause occurrence of erroneous detection. In addition, such an erroneous detection of the shot segmentation will not be easily removed due to a difficulty in a distinction between the erroneous detection and a distribution characteristic of the macro block type at the shot transition point. For example, the camera flash appears frequently in interview scenes, the fast motion of the large object frequently appears in sports videos, and the fast camera motion also frequently appears regardless of a genre, especially, in the sports videos, such as a golf video. Therefore, in a shot segmentation, there exists a need for an algorithm that is capable of minimizing the erroneous detection of the shot occurred by such a camera flash or occurred in a scene on which an object moving in a high speed appears.

In other words, in order to reduce a probability of the erroneous detection, the color histogram comparison method or the macro block type distribution analysis method should be applied more precisely. However, the macro block type distribution analysis method is different for each moving picture encoder and is varied depending on encoding input parameters. Accordingly, if the encoding input parameters are significantly adjusted, another erroneous detection or miss detection may be generated. This invites a difficulty of improvement in an entire performance of the shot segmentation.

On the other hand, the shot, which was detected by the automatic shot transition algorithm as described above, is representative as a key frame and the shot is provided to users in the form of story board, or is used as a means of moving to a desired scene or as a basic input of an algorithm such as a shot clustering. Therefore, the automatic shot transition algorithm requires a high level of accuracy.

### SUMMARY OF THE INVENTION

Accordingly, the present invention has been made keeping in mind the above needs or problems occurring in the prior art, and an object of the present invention is to provide a shot transition detecting method which is capable of increasing an accuracy of a shot segmentation, by providing more precise method of detecting a shot transition by using a multi-level color histogram comparison method.

In order to accomplish the above object, the present invention provides a shot transition detecting method comprising the steps of: extracting a color histogram of three frames in order on time series; obtaining a difference of the color histogram between the three frames and then detecting a shot transition candidate interval by concurrently using arrangement characteristics of the difference of the color histogram; and examining a distribution of a macro block type within the shot transition candidate interval and verifying whether a shot transition is present or not within the shot transition candidate interval.

Preferably, said step of detecting a shot transition candidate interval includes generating a histogram difference vector consisting of a histogram difference between three frames; and determining whether a concerned interval is the shot transition candidate interval by using a characteristic of each element value of the histogram difference vector.

Preferably, said step of verifying whether a shot transition is present or not includes verifying whether a shot transition is present or not by concurrently using characteristics of the macro block type of a P frame and the macro block type of a B frame within a concerned interval.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view for illustrating an example of a MPEG video sequence;

FIG. 2 is a schematized view for explaining a multicolor histogram comparison method according to the present invention;

FIG. 3 is a flowchart for explaining a shot transition detecting method according to the present invention;

FIG. 4 is a view for illustrating rates of intra-coded blocks at a point where a hard cut is generated;

FIG. 5 is a view showing a distribution of a macro block type when the hard cut is generated; and

FIG. 6 is a view for explaining a relationship between a forward prediction and a gradual shot variation in a MPEG video sequence.

### DESCRIPTION OF THE PREFERRED EMBODIMENTS

Hereinafter, the present invention will be in detail described through embodiments with reference to the accompanying drawings.

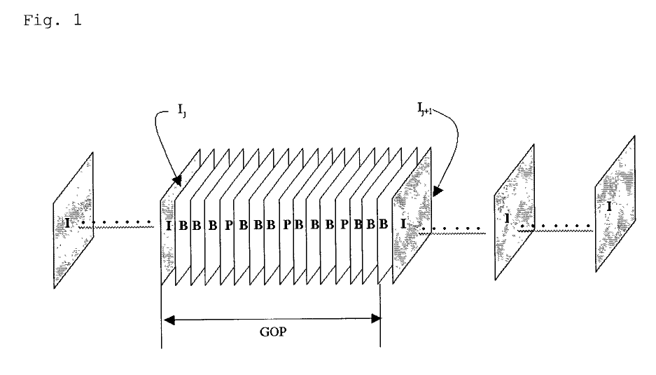

FIG. 1 is a view for illustrating a structure of a video sequence compressed by the MPEG.

Typically, GOP (Group Of Picture) means a frame sequence from an I frame to next I frame. There exist a P frame and a B frame in addition to the I frame in a MPEG compression method. The P frame is coded by using a forwarding prediction and the B frame is coded by concurrently using the forward prediction and a backward prediction. An anchor frame is a basis frame for motion prediction and compensation. The anchor frame for the P frame is an immediately previous I frame or P frame and the anchor frame for the B frame is an immediately previous and next I frame and/or P frame.

In the shot transition detecting method of the moving picture video according to the present invention, the shot transition is detected with the I frame as a predetermined unit.

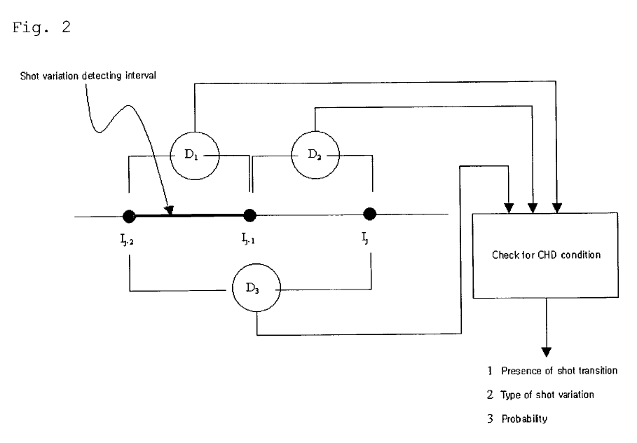

FIG. 2 is a schematized view for explaining a multi-level color histogram comparison method for minimizing an erroneous detection of the shot transition, according to the present invention.

In the following description, Iₖ (k= . . . , j−2, j−1, j, . . . ) means a k-th I frame.

A more robust shot segmentation engine is implemented by obtaining a color histogram difference D1 between an Iⱼ₋₂ frame and an Iⱼ₋₁ frame, a color histogram difference D2 between an Iⱼ frame and an Iⱼ₋₁ frame, and a color histogram difference D3 between an Iⱼ frame and an Iⱼ₋₂ frame, and concurrently using these color histogram differences D1, D2 and D3. More particularly, it is checked whether these color histogram differences D1, D2 and D3 satisfy color histogram difference (CHD) condition of the shot transition. If satisfied, the shot transition is considered to have been generated.

Now, an application example of a comparison between the color histograms in the present invention will be in detail described.

Typically, when the shot transition is generated due to a hard cut between the Iⱼ₋₂ frame and the Iⱼ₋₁ frame, D1 shows a relatively large value and D2 shows a relatively small value. If both of D1 and D2 show a large value, it is commonly considered as a phenomenon exhibited by fast camera motion or fast object motion and, therefore, an erroneous detection will be significantly reduced.

However, although both of D1 and D2 show a large value, there exists a shot transition due to the hard cut. This is a case in which a first portion of a new shot begins with the fast object motion or the fast camera motion. At this point, there is a need to separate a case that both of D1 and D2 are large due to the shot transition and a case that both of D1 and D2 are large due to the fast object motion and the fast camera motion. D3 is used for accomplishing such a separation.

Typically, a ratio D1/D3 in the shot transition due to the hard cut appears larger than that in the shot transition due to the fast object motion and the fast camera motion.

On the other hand, in case of an instantaneous camera flash, both of D1 and D2 are relatively very large while D3 is relatively very small. This case may be considered as the instantaneous camera flash since it is not the hard cut.

By using the comparison of the color histogram as described above, the erroneous detection due to the camera flash can be reduced. In other words, when D1 and D2 for the color histogram are used or D1, D2 and D3 are concurrently used, the erroneous detection in a hard cut detecting algorithm can be minimized.

On the other hand, in the gradual shot transition method including a fade, a dissolve, a wipe, etc, D1+D2 appears in theory almost similar to D3. However, D1+D2 is not equal in reality to D3 due to used different color spaces (including RGB, YCrCb, HSV, etc.) and quantization methods. But, as a relationship of τ₁<(D1+D2)/D3<τᵤ is satisfied, if τ₁ and τᵤ are properly set, the erroneous detection of the gradual shot transition can be reduced. Here, τ₁ and τᵤ mean threshold values.

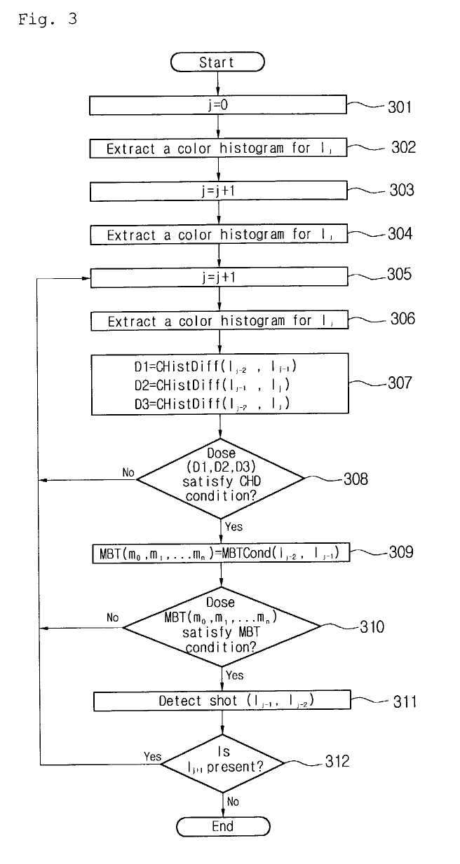

FIG. 3 is a shot segmentation algorithm to which the shot transition detecting method of the present invention is applied.

Referring to FIG. 3, the shot transition detecting method of the present invention consists generally of a first step of preparation (301 to 304), a second step of detecting candidates (305 to 308), and a third step of verifying the candidates (309 to 311).

In the first step of preparation (301 to 304), a color histogram for two successive I frames Iⱼ₋₂ and Iⱼ₋₁ is extracted. In the second step of detecting the candidates (305 to 308), a color histogram for a current I frame Iⱼ is extracted (306), histogram difference vectors D1, D2 and D3 for consisting of three color histogram differences are obtained (307), and it is checked whether each of these vectors satisfies the color histogram difference (CHD) condition (308).

In the step (307), CHistDiff(Iⱼ₋₂, Iⱼ₋₁) is a function for obtaining the color histogram difference D1 between Iⱼ₋₂ frame and Iⱼ₋₁ frame, CHistDiff(Iⱼ₋₁, Iⱼ) is a function for obtaining the color histogram difference D2 between Iⱼ₋₁ frame and Iⱼframe, and CHistDiff(Iⱼ₋₂, Iⱼ) is a function for obtaining the color histogram difference D3 between Iⱼ₋₂ frame and Iⱼ frame.

The color histogram difference (CHD) condition with respect to the shot transition in the present invention is as follows:

[Hard Cut Condition]

1. D1>τ₁ && D2<τ₂ (High Probability)

2. D1>τ₃ && D2>τ₃ && D1/D3>τ₄ && D3>τ₅ (Low Probability)

[Gradual Transition Condition]

1. D1>τ₆ && D2<τ₆ && D3<τ₇ (High Probability)

2. D1>τ₆ && D2>τ₆ && τ₈<(D1+D2)/D3<τ₉ (Low Probability)

[Shot Non-transition Condition ]

Do not Satisfy [Hard Cut Condition] && [Gradual Transition Condition] Where, τₓ is a prescribed threshold value. By adjusting this threshold value, shot segmentation performance can be improved.

If the histogram difference vectors D1, D2 and D3 satisfy the color histogram difference (CHD) condition, the step of verifying the candidates (below 309) is performed for a concerned interval (Iⱼ₋₂, Iⱼ₋₁). If not so, the procedure returns to the step (305) for performing the shot transition detecting algorithm for next interval.

Now, the third step of verifying the candidates (309 to 312) will be described.

In the step of verifying the candidates, MBTCond(Iⱼ₋₂, Iⱼ₋₁) is a function whose input is macro block type information for the P frame and the B frame between Iⱼ₋₂ and Iⱼ₋₁ and whose output is macro block type characteristic vector MBT(m₀,m₁ . . . mₙ).

In the step (309), the macro block type characteristic vector can be obtained by using macro block type distribution of the P frame and the B frame in an input interval (Iⱼ₋₂, Iⱼ₋₁). In next step (310), it is checked whether the macro block type characteristic vector satisfies macro block type distribution condition for the shot detection. If so, it is indicated that the shot transition is generated in the input interval (Iⱼ₋₂, Iⱼ₋₁). If necessary, a precise shot transition position is recorded (311). In next step (312), it is checked whether the I frame is further present or not. If so, the procedure returns to the step (305) for performing the shot transition detecting algorithm for next interval. If not so, the procedure is terminated.

However, in the step (310), if the macro block type characteristic vector does not satisfy the macro block type distribution condition for the shot detection, it is considered that the shot transition is not generated in the input interval (Iⱼ₋₂, Iⱼ₋₁) is indicated. Next, the procedure returns to the step (305) for performing the shot transition detecting algorithm for next interval.

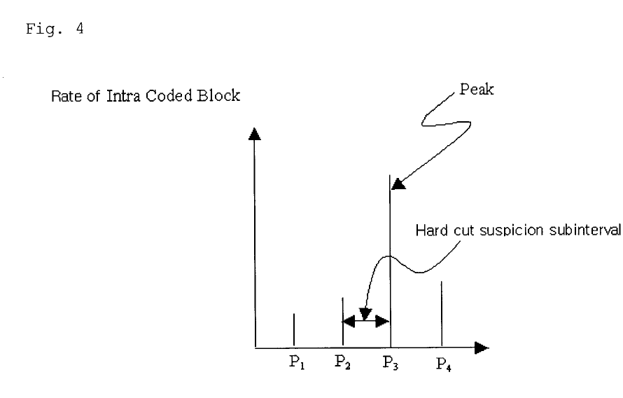

FIGS. 4 to 6 are views for explaining an algorithm of the third step of verifying the candidates.

Generally, a peak appears in rates of intra-coded blocks of P frame within an interval in which a hard cut is generated. A reference pattern for clearly distinguishing the hard cut generating interval from other common intervals is modeled to appear in B frames between a concerned peak and the P frame or the I frame previous to the concerned peak.

For example referring FIG. 4, it is assumed that four P frames P₁, P₂, P₃ and P₄ are present within a concerned GOP and a peak above a predetermined threshold value is generated in the frame P₃. Since this case may be a case that a hard cut is generated in a subinterval P₂-P₃, the reference pattern of the B frame for the subinterval P₂-P₃ is checked.

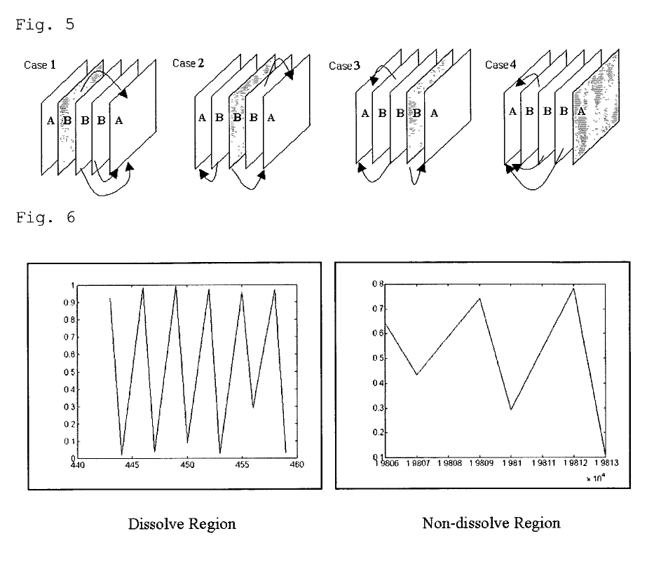

FIG. 5 is a schematized view showing a coding feature of B frames in the hard cut generating subinterval with a reference of an extreme number of macro blocks in one anchor frame of two adjacent anchor frames, where a dark frame indicates a shot boundary point. That is, arrows directed from B frames point to one anchor frame referred in extreme numbers, of the two adjacent anchor frames.

Referring to FIG. 5, in each of four cases, arrows directed from B frames placed at both sides of the shot boundary point indicate a respectively opposite anchor frame referring an extreme number of macro blocks.

The presence of such a reference pattern gives the verification that the shot transition has been present.

FIG. 6 is a schematized view showing a characteristic of FMBR (=M_{fwd}/(M_{fwd}+M_{bwd})(M_{fwd}: the number of forward reference macro block, M_{bwd}: the number of backward reference macro block) of the B frame adjacent to an anchor frame within an interval in which a fade or a dissolve is generated and a characteristic of FMBR within an interval in which a fade or a dissolve is not generated.

FIG. 6 shows that FMBR is largely swung during above a prescribed period in B frames adjacent to an anchor frame in a shot transition interval using the fade or the dissolve and such a characteristic does not appear in otherwise intervals. In addition, since a characteristic macro block type distribution appears in the shot transition using a wipe or a special effect, such a distribution can be used to detect the shot transition.

In the third step of verifying the candidates, only hard cut condition for the macro block type can be checked in an interval to which the information on the type of the shot transition using the histogram vector described earlier is provided as an additional input and which is determined to be the hard cut by the condition of the color histogram, and only gradual variation condition can be checked in an interval which is determined to be the gradual shot transition.

On the other hand, by using an adaptable method in which a threshold value of the macro block type condition is loosely adjusted in a case of high probability in the condition of the color histogram and the threshold value is strictly adjusted in a case of low probability in the condition of the color histogram, the performance of the entire shot transition detecting algorithm can be enhanced.

As described above, the present invention can reduce the erroneous detection of the shot transition due to the instantaneous camera flash, the fast object motion, and the fast camera motion through the comparison in multi-step between the color histograms.

In addition, although the present invention further requires an additional process, i.e., color histogram comparison operation, when viewed from the entire segmentation engine, since the increased amount of process is extremely slight, the present invention can contribute to the improvement of performance of the shot transition detecting algorithm.

In addition, when the shot transition detecting method of the present invention is used, the performance of a key frame interface such as a story board can be enhanced by constructing a fast and precise shot segmentation engine, the satisfaction of user for non-linear browsing is raised, and a basis on which a higher level of shot clustering engine is constructed can be provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of detecting a shot transition of a moving picture video, comprising the steps of:
obtaining color histogram differences between three frames placed at different points of time on time series; and
detecting the shot transition by using arrangement characteristics of the color histogram differences concurrently.

2. The method according to claim 1, wherein the arrangement characteristics of the color histogram differences are placed in the order of a first frame, a second frame, and a third frame, and the shot transition is detected by using a color histogram difference (D1) between the first frame and the second frame, a color histogram difference (D2) between the second frame and the third frame, and a color histogram difference (D3) between the first frame and the third frame.

3. The method according to claim 1, wherein the frames are I frame in a stream encoded by MPEG or H.26x series.

4. The method according to claim 2, wherein a concerned interval is set as a cut candidate interval if the color histogram differences (D1, D2, D3) satisfy hard cut condition,
the concerned interval is set as a gradual shot transition candidate interval if the color histogram differences (D1, D2, D3) satisfy gradual shot transition condition, and
if the hard cut condition and the gradual shot transition condition are not satisfied, it is determined that the shot transition is not generated in the concerned interval.

5. The method according to claim 4, wherein in addition to the shot transition candidate, a type of shot variation and a probability of shot variation are outputted concurrently.

6. The method according to claim 4, wherein the hard cut condition is set as follows:
condition 1. D1>τ₁ && D2<τ₂,
condition 2. D1>τ₃ && D2>τ₃ && D1/D3>τ₄ && D3>τ₅.

7. The method according to claim 6, wherein
a case corresponding to the condition 1 is considered as a high probability for the hard cut, and
a case corresponding to the condition 2 is considered as a low probability for the hard cut.

8. The method according to claim 4, wherein the gradual shot transition condition is set as follows:
condition 1. D1>τ₆ && D2<τ₆ && D3<τ₇,
condition 2. D1>τ₆ && D2>τ₆ && τ₈<(D1+D2)/D3<τ₉.

9. The method according to claim 8, wherein
a case corresponding to the condition 1 is considered as a high probability for the gradual shot transition, and
a case corresponding to the condition 2 is considered as a low probability for the gradual shot transition.

10. A method of detecting a shot transition of a moving picture video, comprising the steps of:
extracting a color histogram of three frames in order on time series;
obtaining a difference of the color histogram between the three frames and then detecting a shot transition candidate interval by concurrently using arrangement characteristics of the difference of the color histogram; and
examining a distribution of a macro block type within the shot transition candidate interval and verifying whether a shot transition is present or not within the shot transition candidate interval.

11. The method according to claim 10, wherein said step of detecting a shot transition candidate interval includes generating a histogram difference vector consisting of a histogram difference between three frames; and
determining whether a concerned interval is the shot transition candidate interval by using a characteristic of each element value of the histogram difference vector.

12. The method according to claim 11, wherein in addition to the shot transition candidate, a type of shot variation and a probability of shot variation are outputted concurrently.

13. The method according to claim 10, wherein said step of verifying whether a shot transition is present or not includes verifying whether a shot transition is present or not by concurrently using characteristics of the macro block type of a P frame and the macro block type of a B frame within a concerned interval.

14. The method according to claim 13, wherein whether the hard cut is generated or not is verified based on the presence of a peak of intra coded block rates and the presence of hard cut characteristic in a prescribed frame within a concerned GOP for the shot transition detection.

15. The method according to claim 13, wherein whether the gradual shot transition is present or not is verified based on swing characteristic of a rate of forward macro block or a rate of backward macro block and a forward prediction rate in a prescribed frame within a concerned GOP for the shot transition detection.

16. The method according to claim 12, wherein a condition on whether the shot transition is present or not is adjusted based on the type of shot variation and the probability of shot variation.

17. A method of detecting a shot transition of a moving picture video, comprising the steps of:
extracting a color histogram of three adjacent I frames in order on time series;
obtaining a difference of a pair of the color histogram combined from the three adjacent I frames;
detecting a shot transition candidate interval by concurrently using arrangement characteristics of the difference of the color histogram; and
examining a distribution of a macro block type within the shot transition candidate interval, verifying whether a shot transition is present or not within the shot transition candidate interval, and if it is verified that the transition is present, identifying the shot transition candidate interval as a separate shot.
